(19) United States
(12) Patent Application Publication
(10) Pub. No.: US 2015/0071091 A1
(43) Pub. Date: Mar. 12, 2015

(54) Apparatus And Method For Monitoring Network Performance

(71) Applicant: Alcatel-Lucent USA Inc., Murray Hill, NJ (US)

(72) Inventors: Ravi Govil, Camarillo, CA (US); Khurram Khawaja, Simi Valley, CA (US); Mark Owens, Seal Beach, CA (US)

(73) Assignee: Alcatel-Lucent USA Inc., Murray Hill, NJ (US)

(21) Appl. No.: 14/024,895

(22) Filed: Sep. 12, 2013

(51) Int. Cl. H04L 12/26; H04L 12/24

(52) U.S. Cl. CPC H04L 43/0876; H04L 41/12
USPC 370/252

(57) ABSTRACT

A manner of monitoring network performance using an AMA (active monitoring agent). A network manager, generally operating on one of the network nodes, establishes an AMA associated with two end points, at least one of the end points including a VM running an application. VM migration is monitored, and if a detected migration is associated with an active AMA then the new endpoint or endpoints associated with the AMA are calculated and a new AMA is established. A VM pair table is updated to reflect the change.

### TECHNICAL FIELD

The present invention relates generally to the field of communication networks, and, more particularly, to a method and apparatus monitoring network performance using an AMA (active monitoring agent) or similar mechanism.

### BACKGROUND

The following abbreviations are herewith defined, at least some of which are referred to within the following description of the state-of-the-art and the present invention.

### AFN Application Fluent Network

### AMA Active Monitoring Agent

### ARP Address Resolution Protocol

### HA High Availability

### LAN Local Area Network

### MAC Media Access Control

### MEP Media End Point

### NMS Network Management System

### OAM Operation, Administration and Maintenance

### SAA Service Assurance Agent

### VLAN Virtual LAN

### VM Virtual Machine

Computing devices are often connected together through a network such as a LAN (local area network), MAN (metropolitan area network), or data center that is made up of nodes (for example, bridges, switches, routers, etc.) to facilitate communication and the sharing of computing resources. These networks may serve, for example, business enterprises, university campuses, or local communities. Note that these examples are provided for illustration; the present invention may be implemented in a wide variety of networks.

When such computer networks are implemented, it is often if not always desirable to monitor performance characteristics so that modifications or corrections may be made as appropriate. One way of monitoring a network is through the use of an AMA. An AMA is, for example, implemented in two end points of the network, sometimes referred to as MEPs (media end points). When the AMA is established, this pair of devices communicates with each other using a known messaging scheme so that certain performance characteristics can be measured, for example the RTT (round trip time) or jitter associated with exchanged messages.

For the purposes of establishing an AMA, an MEP or other end device may be identified by the IP (Internet Protocol) address of the switch at which the MEP connects to the network, as well as the slot and port associated with the particular MEP. A problem arises, however, when network applications are implemented in VMs (virtual machines) because these VMs may migrate from one physical location or “host” to another. Yet it is sometimes desirable to monitor particular applications as opposed to simply setting up an AMA only to watch two end points. This and other problems are addressed by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed at a manner of monitoring network performance using an AMA (Active monitoring agent) or similar mechanism, and is of particular advantage in networks that implement VMs (Virtual Machines) that may migrate from one physical host to another.

In one aspect, the present invention is a method for monitoring network performance including establishing a first AMA to monitor communication between at first set of nodes, at least one of the first set of nodes comprising a VM, detecting that a VM has migrated, determining the new node location of the migrated VM, and establishing a second AMA to monitor communication between a second set of nodes, the second set of nodes comprising the migrated VM. The invention may also include populating a VM pair table to include the first and the second AMA. In some embodiments, the method may also include disestablishing the first AMA subsequent to detecting that the VM has migrated, in which case the VM pair table may be modified accordingly.

In some embodiments, an existing AMA may be used for monitoring communication relating to one or more additional VM pairs. In this case the method may also include determining whether an existing AMA is being used to monitor communication between the second set of nodes and, if so, not establishing a second AMA. When this occurs, the VM pair table may be updated to reflect the existing AMA. By the same token, the method may in some embodiments include determining whether an existing AMA is being used to monitor communications associated with more than one VM pair prior to disestablishing an AMA and, if so, not disestablishing the AMA.

In some embodiments according to this aspect, the invention may further include receiving a request for a listing of applications running on the network, or on a particular VM. The request may be, for example, for a listing of the top applications that utilize the most network resources. In this case the invention may also include transmitting for display a list including at least some of the applications running on the network or on the particular VM.

The method may further include receiving a request to establish an AMA for an application running on the network. In this case the method may also include locating a pair of nodes associated with the application, monitoring communication between the nodes, and updating a performance table based on the communication monitoring.

In another aspect, the present invention is a network node having a processor, a memory in communication with the processor, and a network manager working in cooperation with a network monitor, a VM locator, and a VM manager.

In yet another aspect, the present invention is a machine readable storage medium having stored thereon program instructions that when executed cause the machine to establish a first AMA to monitor communication between at first set of nodes, at least one of the first set of nodes comprising a VM, detect that a VM has migrated, determine the new node location of the migrated VM, and establish a second AMA to monitor communication between a second set of nodes, the second set of nodes comprising the migrated VM.

In this aspect, the program instructions when executed may also cause the machine to determine whether an existing AMA is being used to monitor communication between the second set of nodes and, if so, not establishing a second AMA, but instead, update the VM pair table may be updated to reflect the existing AMA. The program instructions when executed may also cause the machine to determine whether an existing AMA is being used to monitor communications associated with more than one VM pair prior to disestablishing an AMA and, if so, not disestablishing the AMA.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating an exemplary network according in which the present invention might be advantageously implemented;

FIGS. 2A and 2B are simplified schematic diagrams illustrating a network configured according to an embodiment of the present invention;

FIG. 3 is flow diagram illustrating a method according to an embodiment of the present invention;

FIG. 4 is a flow diagram illustrating a method according to an embodiment of the present invention; and

FIG. 5 is a simplified block diagram illustrating selected components of a network node according to an embodiment of the present invention.

### DETAILED DESCRIPTION

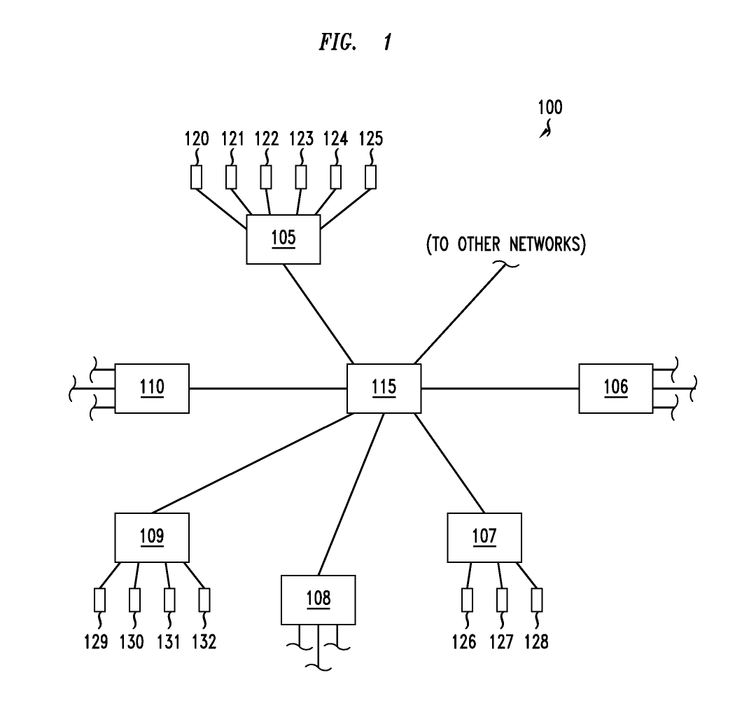

The present invention is directed at a manner of monitoring network performance using an AMA (Active monitoring agent) or similar mechanism. The invention is of particular advantage in networks that implement VMs (Virtual Machines) that are able to migrate from one physical host to another. FIG. 1 is a simplified schematic diagram illustrating an exemplary network 100 according in which the present invention might be advantageously implemented.

In FIG. 1, network 100 is depicted as having a number of switches that are referred to as 105 through 110. Each of switches 105 through 110 is connected to switch 115, through which, in this network, the switches 105 through 110 may communicate with each other, and with devices (not shown) or networks (for example, the Internet) external to network 100.

Each of switches 105 through 110 in exemplary network 100 may also be connected to one or more end points. For example, switch 105 is connected to end points 120 through 125, switch 107 is connected to end points 126 though 128, and switch 109 is connected to end points 129 through 132.

End points 120 through 132 may be, for example, user devices or servers or other devices that may communicate through network 100 upon being connected to one of the switches 105 through 110. Note that the topology of network 100 is exemplary and many other configurations are possible. In many if not most actual implementations, the number of switches and end points may be much higher.

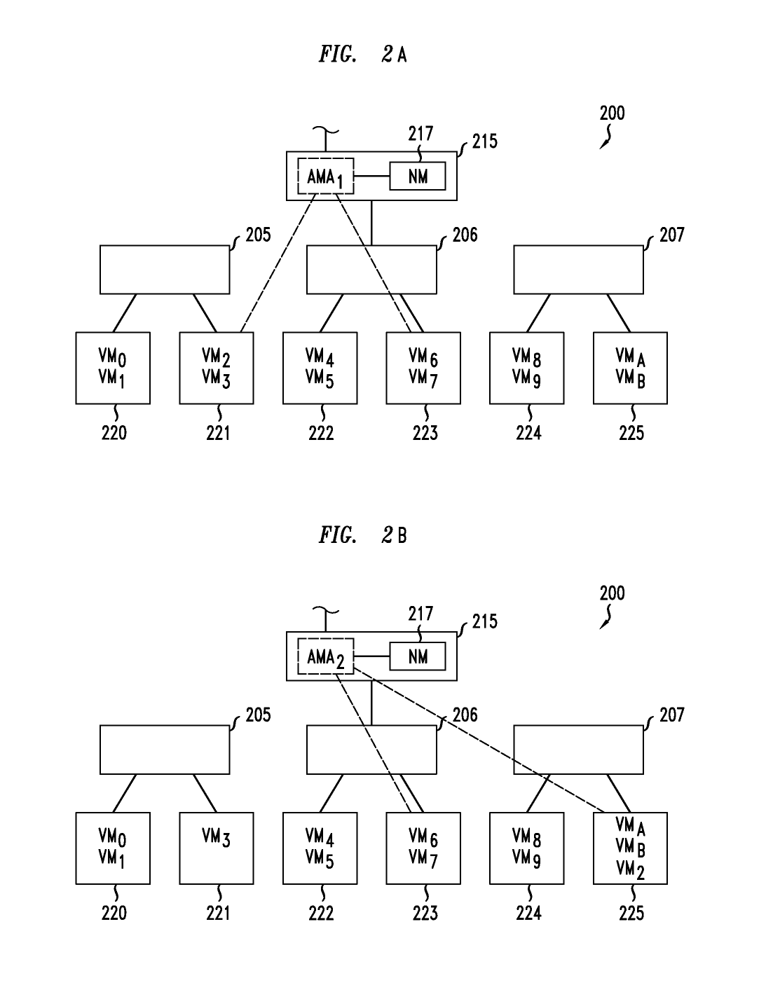

Implementation of the present invention in a network such as network 100 will now be shown, beginning with reference to FIGS. 2A and 2B. FIGS. 2A and 2B are simplified schematic diagrams illustrating a network configured according to an embodiment of the present invention. Note that network 200 is similar in some ways to exemplary network 100 but for convenience shows only switch 215 connected to switches 205 through 207, each of which is connected to two end points. End points 220 and 221 are connected to switch 205, end points 222 and 223 are connected with switch 206, and end points 224 and 225 are connected with switch 207. As with network 100, the number and configuration of the components may vary from implementation to implementation, and over time within a given implementation. Note that as used herein, “connected” does not necessarily imply “directly connected” (that is, with no intervening devices), although that will often be the case. In some cases the connection may be wireless.

In a preferred embodiment, switches 205 through 207 are implemented as OmniSwitch 6900 switches, and switch 215 is implemented as an OmniSwitch 10K VC (virtual chassis) device.

In the embodiment of FIG. 2A, each of the end points is operational to include one or more VMs (virtual machines). A VM includes executable program instructions stored on a memory device resident in or accessible to the end point. The program instructions may be executed, for example, by a processor of the end point. The operation and configuration of the end point is therefore a function of the VM or VMs operational upon it.

VMs can migrate from one end point to another, in effect changing the configuration and operation of the relevant end points. VMs may migrate, for example, to accommodate changing network conditions or overuse of network resources. Note that used in this sense, the term “migrate” may imply actually installing or de-installing the VM program instructions on respective devices, or simply activating or deactivating program instructions already installed. In the embodiment of FIG. 2A, each of the depicted end points has two VMs running on it. The VMs are referred to as VM₀ through VM_{B}. VM₂ and VM₃ are, for example, currently running on end point 221.

In this embodiment, switches 205 through 207 handle traffic to and from the respective end points 220 through 225 to which they are connected. Switches 205 through 207 are in turn each connected to switch 215. Switch 215 enables communication between the end points and each other via any of switches 205 through 207, and with networks and devices (not shown) external to network 200. Switch 215 may also include a network manager (NM) module 217. The network management module includes executable program instructions stored preferably on a tangible, non-transitory memory device resident in or accessible to the end point. The program instructions may be executed, for example, by a processor of the switch 215. Note, however, that the network management module 217 may be resident elsewhere as well, and be implemented using a different memory device and processor (not shown).

The network management module 217 may perform a variety of functions, but in the context of the present invention it is responsible for monitoring certain aspects of network performance. An AMA is one tool for doing so. Note that herein, the term “AMA” is intended to broadly include all similar mechanisms, such as SAA (Service Aware Agent) whether or not actually referred to using that term. In a typical implementation of an AMA two end points may be selected for monitoring, each identified by the switch to which the end points are respectively connected, and by the specific slot and port through which that connection is made. The AMA is set up with the cooperation of the end points, which for example periodically send a set of messages to each other via the network 200. Characteristics such as RTT (round trip time) and jitter may be measured based on receipt of these messages and the responses to them. Ideally, the measured characteristics are stored in a table for analysis and reporting or display.

Note that when an AMA is employed in implementing the present invention, it may monitor communications between the two end points themselves, in some cases even discriminating by port, while in other implementations the AMA may only monitor communications between the switches to which the end points are connected. The latter is presently preferred in most if not all implementations due primarily to efficiency, especially when a given AMA may be associated with more than one VM pair, and the expectation that the communications between the switches and the endpoints will have minimal impact on analysis of performance characteristics.

In the embodiment of FIG. 2A, AMA₁ is set up by network manager 217 in order to monitor traffic between VM₂ and VM₇. Note that while AMA₁ has been configured in switch 215, in some implementations it may be resident elsewhere. (The broken lines represent the AMA relationship and not separate lines of communication.) A VM pair table 218 is populated to provide a record of the AMA associated with these two VMs.

As an illustration, the VM pair table may be represented as follows:

| | | | | | | |
|---|---|---|---|---|---|---|
| VM₂ | VM₇ | AMA₁ | 2013-01-03 | 10:20:53 | 2013-03-03 | 22:20:53 |

showing that AMA₁ has been in place for two and one-half days. Note that in this embodiment, the VM pair table contains no statistics related to VM₂-VM₇ traffic, these are recorded elsewhere.

As mentioned above, in a static network scenario, this arrangement may continue indefinitely. Network 200, however, is not a static network in the sense that VMs may migrate to other devices. This is illustrated in FIG. 2B. As should be apparent, FIG. 2B is simply an illustration of network 200 generally as shown in FIG. 2A, except that VM2 has migrated from end point 221 to end point 225.

When this occurs, AMA₁ is no longer providing relevant statistical information regarding the characteristics of the transmissions between VM₂ and VM₇. In accordance with this embodiment of the present invention, however, the migration of VM₂ is detected and the new end point (or end points) ascertained. The network manager 217 then establishes a new AMA, here illustrated as AMA₂ in order to gather statistics regarding the communications between VM₂ and VM₇. Preferably, VM pair table 218 is populated to provide a record of the new AMA associated with these two VMs, while the previous relationship is also shown. In this case, the VM pair table may be represented as follows:

| | | | | | | |
|---|---|---|---|---|---|---|
| VM₂ | VM₇ | AMA₁ | 2013-01-03 | 10:20:53 | 2013-04-03 | 12:20:53 |
| VM₂ | VM₇ | AMA₂ | 2013-04-03 | 12:20:53 | 2013-04-03 | 22:20:53 |

showing that AMA₁ remained in place for 3 days and 2 hours, when it was superseded in the VM pair table by AMA₂, which itself has been in place for 10 hours. This process, which of course may continue for each change in VM location, will now be described in greater detail.

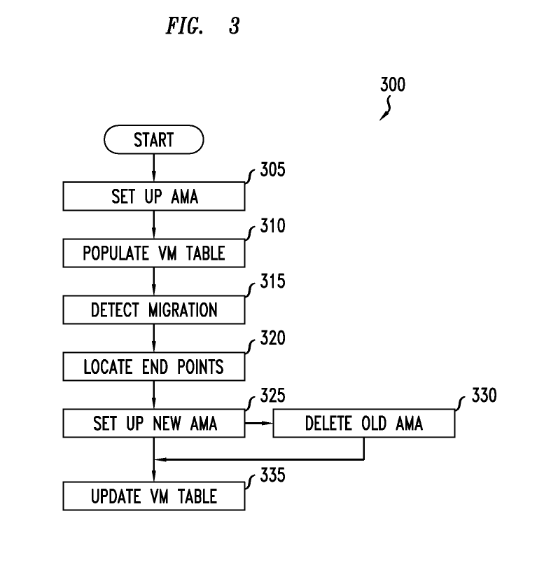

FIG. 3 is a flow diagram illustrating a method 300 of network monitoring according to an embodiment of the present invention. Initially, it is presumed that the necessary components are available and operational according to this embodiment. The method then begins when an AMA is established (step 305). For purposes of illustration, the AMA is presumed to involve communications between two end points, at least one of them operable as a VM. Note, however, application mobility is not a requirement unless recited in a particular embodiment. In the embodiment of FIG. 3, a VM pair table is then populated to reflect the established AMA (step 310).

In this embodiment, migration of one or both of the VMs of the VM pair currently associated with the AMA is detected (step 315). This migration may occur for a number of reasons, for example having to do with equipment failure or traffic management. Note that while it is possible that both VMs will migrate at about the same time, for convenience the discussion herein will describe processes in terms of the migration of a single VM at any one time. Serial or simultaneous migrations of both VMs in a VM pair are handled analogously.

With this in mind, in this embodiment once migration of a VM is detected, the new end points associated with the VM are located (step 320). When the endpoints have been located a new AMA is established (step 325). In this embodiment, when the new AMA is established at step 325, the AMA previously monitoring the VM pair is removed (step 330). The VM pair table is then updated (step 335) with the new AMA information.

In some embodiments (not shown), an existing AMA may be used for monitoring communication relating to one or more additional VM pairs. In this case the method may also include determining whether an existing AMA is being used to monitor communication between the second set of nodes and, if so, not establishing a second AMA. When this occurs, the VM pair table may be updated to reflect the existing AMA. By the same token, the method may in some embodiments include determining whether an existing AMA is being used to monitor communications associated with more than one VM pair prior to disestablishing an AMA and, if so, not disestablishing the AMA.

Note that the determination of whether an existing AMA is associated with more than one VM pair may take into account the level to which the AMA is monitoring communications, for example, between two switches rather than between two endpoints.

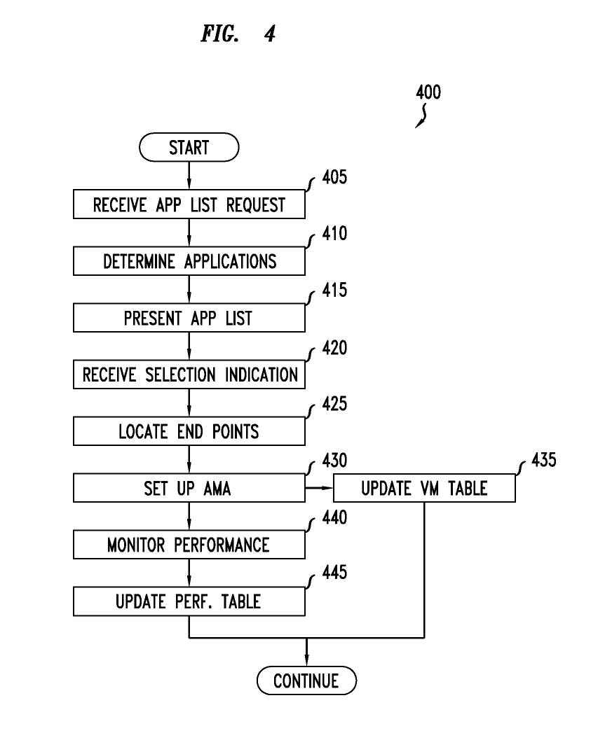

The AMA set up at step 305 of method 300 (shown in FIG. 3) monitors the communication characteristics between a pair of VMs. This VM pair may be selected in a variety of ways as more fully described in reference to FIG. 4.

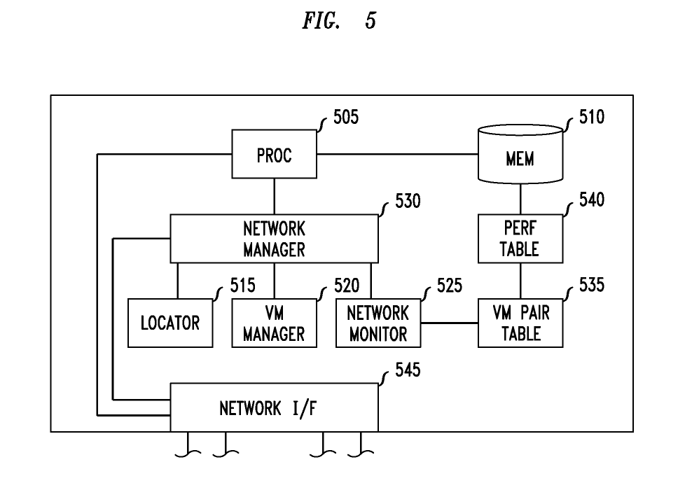

FIG. 4 is a flow diagram illustrating a method 400 of network monitoring according to another embodiment of the present invention. Again, it is initially presumed that the necessary components are available and operational according to this embodiment. In this embodiment, the process begins when a network monitor (see, for example, FIG. 5) receives a request (step 405) to list of some or all application processes running in the network, preferably ranked to show which are consuming the most network resources (for example, memory and CPU resources).

In the embodiment of FIG. 4, upon receiving a request, the network monitor then determines (step 410) which are the top applications, that is those that are consuming the most resources. Other selection criteria may of course be used in other embodiments. In the embodiment of FIG. 4, the top applications (or a list of all the applications) are then presented (step 415) to the network operator, for example by tabular display on a display console in that is in communication with the network.

It is anticipated that when such a presentation is made that the network operator is presented with the top applications a selection may be made to have one of the applications monitored. (If more than one selection is made each is handled as that occurs.) The network monitor then receives an indication of the selection (step 420) that the network operator has made.

Note that some or all of the operations of FIG. 4 described above presume a network with AFN (application fluent network) functionality. If this is not the case, or if an alternative is desired, then the application or applications to be monitored may be selected in some other manner.

In the embodiment of FIG. 4, when the selection indication is received, the media end points of the VMs associated with the selected application are determined (step 425) and an AMA established (step 430). When the AMA has been established, a VM pair table is appropriately annotated and performance characteristics can be determined (step 435). Once the AMA is in place, performance characteristics are monitored (step 440). Values representative of the measured performance characteristics are then stored (step 445) in, for example, a performance table co-resident with the network monitor.

The process then continues as updated performance characteristics are determined and the performance table updated according to the AMA implementation schedule, if one is in force. Naturally, the VMs are preferably also monitored (not shown in FIG. 4), and if one or both of the VMs of an AMA-monitored VM pair migrates, the process of method 400 may proceed with the process of method 300, beginning at step 315.

Although not shown, it is noted that some or all of the contents of either the VM pair table or the performance table may be presented for display to the network operator, either continually or upon request, or at the occurrence of some threshold event such as when one AMA replaces another.

Note that the sequence of operation illustrated in FIGS. 3 and 4 represent exemplary embodiments; some variation is possible within the spirit of the invention. For example, additional operations may be added to those shown in FIGS. 3 and 4, and in some implementations one or more of the illustrated operations may be omitted. In addition, the operations of the method may be performed in any logically-consistent order unless a definite sequence is recited in a particular embodiment.

FIG. 5 is a simplified block diagram illustrating selected components of a network node 500 according to an embodiment of the present invention. Network node 500 may in some cases be implemented as switch 215 shown in FIGS. 2A and 2B and in other cases implemented on a different node. In either case, the node 500 may perform other functions in addition to those represented in FIG. 5. In the embodiment of FIG. 5, node 500 includes a processor 505 for controlling the operation of some or all of the other components of the node according to program instructions stored on memory device 510 or received from without the node. Memory 510 is a tangible data storage device and is non-transitory in the sense of not consisting merely of a propagating signal.

In the embodiment of FIG. 5, node 500 also includes a network management system 530 sometimes referred to simply as a network manager (NM). Network manager 530 is configured to set up an AMA to monitor communication between two end points and in this embodiment to coordinate the operation of locator 515, VM manager 520, and network monitor 525. Note that while for illustration these are shown as separate components, they may in implementation share hardware and software resources. Each may be implemented in hardware or software executing on hardware components. A network interface 545 allows the switch to communicate via a computer network (not shown in FIG. 5).

In this embodiment, locater 515 determines the location of end points, preferably resolving the location to a specific switch, slot, and port interface. The locator 515 in this embodiment surveys ARP and bridging tables of the various network devices, and is aware of network adjacencies, and uses some or all of this information in the location determination. The VM manager 520 detects VM movement within the network, for example by listening for events from a virtualization provider such as VMWare vCenter or Citrix Xen Server. If a VM migration is detected, the VM manager 520 initiates a poll of involved network switches and sends a request to the locator 515 to initiate the calculation of the location of the end point devices.

In the embodiment of FIG. 5, network monitor 525 maintains VM pair table 535, tracking each AMA that has been established (and deleting information relating to AMAs no longer used). In this embodiment, network monitor 525 receives notification of VM migration from VM manager 520 and determines whether a given migration involves a VM being monitored. If so, the network monitor 520 initiates the creation of a new AMA by network manager 530 and updates the VM pair table as appropriate.

In this embodiment, node 500 also includes a performance table 540 for storing at least the collected performance data relating to monitoring according to the present invention. Note that in some implementations, this performance data may initially be stored on the end points associated with the AMA. In this case it may be collected periodically, or whenever the AMA is modified to include new end points subsequent to VM migration, or both. The performance data may be maintained elsewhere as well.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for monitoring network performance, comprising:
establishing a first AMA (active monitoring agent) to monitor communication between at first set of nodes, at least one of the first set of nodes comprising a VM;
detecting that a VM has migrated; and
determining the new node location of the migrated VM.

2. The method of claim 1, further comprising populating a VM pair table to include the first AMA.

3. The method of claim 1, further comprising establishing a second AMA to monitor communication between a second set of nodes, the second set of nodes comprising the migrated VM.

4. The method of claim 3, further comprising updating the VM pair table to include the second AMA.

5. The method of claim 1, further comprising determining whether the first AMA is associated with more than one VM pair.

6. The method of claim 5, further comprising disestablishing the first AMA subsequent to detecting that the VM has migrated if the first AMA is not associated with more than one VM pair.

7. The method of claim 1, further comprising receiving a request for a listing of applications running on the network.

8. The method of claim 7, wherein the request comprises a request for a listing of the top applications running on the network.

9. The method of claim 7, further comprising transmitting a list for display, the list for display comprising at least some of the applications running on the network.

10. The method of claim 1, further comprising receiving a request to establish an AMA.

11. The method of claim 10, wherein the request comprises an indication of an application running on the network.

12. The method of claim 11, further comprising locating a pair of nodes associated with the application.

13. The method of claim 1, further comprising monitoring communication between the nodes.

14. The method of claim 13, further comprising updating a performance table based on the communication monitoring.

15. The method of claim 1, wherein the AMA is an SAA (service assurance agent).

16. A network management node, comprising:
a processor;
a memory in communication with the processor;
a network monitor;
a VM locator; and
a VM manager.

17. A machine readable storage medium having stored thereon program instructions that when executed cause the machine to:
establish a first AMA to monitor communication between at first set of nodes, at least one of the first set of nodes comprising a VM;
detect that a VM has migrated;
determine the new node location of the migrated VM; and
establish a second AMA to monitor communication between a second set of nodes, the second set of nodes comprising the migrated VM.
